(19) United States
(12) Patent Application Publication
(10) Pub. No.: US 2011/0142421 A1
(43) Pub. Date: Jun. 16, 2011

(54) APPARATUS AND METHOD FOR MANAGING POWER OF DIGITAL BROADCASTING RECEIVER

(75) Inventor: Hyung-Suk KIM, Suwon-si (KR)

(73) Assignee: SAMSUNG ELECTRONICS CO. LTD., Suwon-si (KR)

(21) Appl. No.: 12/970,048

(22) Filed: Dec. 16, 2010

(30) Foreign Application Priority Data
Dec. 16, 2009 (KR) 10-2009-0125390

(51) Int. Cl. H04N 5/76

(52) U.S. Cl. 386/296; 386/E05.001

(57) ABSTRACT

An apparatus and a method for managing power of a digital broadcasting receiver are provided. The apparatus includes a user setting unit for requesting power setting of the digital broadcasting receiver according to data input through a user interface, a pattern recognition unit for recognizing a use pattern through data input according to use of the digital broadcasting receiver, and for requesting power setting of the digital broadcasting receiver according to the recognized use pattern, and a power setting unit for setting the power of the digital broadcasting receiver by a request of the user setting unit and the pattern recognition unit.

### PRIORITY

This application claims the benefit under 35 U.S.C. §119(a) of a Korean Patent Application filed in the Korean Intellectual Property Office on Dec. 16, 2009 and assigned Serial No. 10-2009-0125390, the entire disclosure of which is hereby incorporated by reference.

### BACKGROUND OF THE INVENTION

1. Field of the Invention

The present invention relates to a digital broadcasting receiver. More particularly, the present invention relates to an apparatus and a method for managing power of a digital broadcasting receiver.

2. Description of the Related Art

In general, a digital broadcasting receiver is an apparatus which is configured with a Television (TV) receiver and receives various video data on multi-channel transmitted through a network or a satellite. The digital broadcasting receiver can allow a TV to display satellite or cable broadcasting or perform various additional functions.

Therefore, when a telephone line, a cable TV network, an Asymmetric Digital Subscriber Line (ADSL), etc. are connected to the digital broadcasting receiver, internet search can be performed even without a computer. The use of a digital broadcasting receiver can be classified into use for a cable TV, use for a satellite broadcasting, use for an internet TV, etc. according to broadcasting forms.

The digital broadcasting receiver as described above has propagated rapidly according to a gradual increase of digital broadcasting content. In recent days, the digital broadcasting receiver has been developed to have various additional functions, including not only reception and decoding of digital broadcasting data but also a Video Cartridge Recorder (VCR) function, a home network host function, and the like.

Meanwhile, since the digital broadcasting receiver has the additional functions such as the VCR function and the home network function as described above, there has been a requirement for independently managing power for each function unit in a set-top box in order to prevent power consumption and the increase of heat generation of the set-top box.

### SUMMARY OF THE INVENTION

An aspect of the present invention is to address the above-mentioned problems and/or disadvantages and to provide at least the advantages described below. Accordingly, an aspect of the present invention is to provide an apparatus and a method capable of detecting a connection state of an output end and disabling unused Audio/Video (A/V) output terminals in a digital broadcasting receiver.

Also, an aspect of the present invention provides an apparatus and a method capable of detecting a use pattern and setting an optimized power reduction scheme in a digital broadcasting receiver.

In accordance with an aspect of the present invention, an apparatus for managing power of a digital broadcasting receiver is provided. The apparatus includes a user setting unit for requesting power setting of the digital broadcasting receiver according to data input through a user interface, a pattern recognition unit for recognizing a use pattern through data input according to use of the digital broadcasting receiver, and requesting power setting of the digital broadcasting receiver according to the recognized use pattern, and a power setting unit for setting the power of the digital broadcasting receiver by a request of at least one of the user setting unit and the pattern recognition unit.

Also, in accordance with another aspect of the present invention, a method for managing power of a digital broadcasting receiver is provided. The method includes determining whether input data is data input through a user interface or data input according to use of the digital broadcasting receiver, and setting the power based on a result of the determination.

In accordance with another aspect of the present invention, a method of managing power of a digital broadcasting receiver is provided. The method includes obtaining data related to a use of the digital broadcasting receiver, storing the obtained data, analyzing a pattern of use of the digital broadcasting receiver based on the stored data, and determining whether a power setting of the digital broadcasting receiver is set based on the result of the analysis.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating the configuration of a power management system according to the related art;

FIG. 2 is a block diagram illustrating a configuration of a digital broadcasting receiver according to an exemplary embodiment of the present invention;

FIG. 3 is a block diagram illustrating a configuration of a pattern recognition unit according to an exemplary embodiment of the present invention;

FIG. 4 is a flowchart showing a process for managing power of a digital broadcasting receiver by a pattern recognition unit according to an exemplary embodiment of the present invention; and

FIG. 5 is a flowchart showing a process for managing power by a digital broadcasting receiver according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

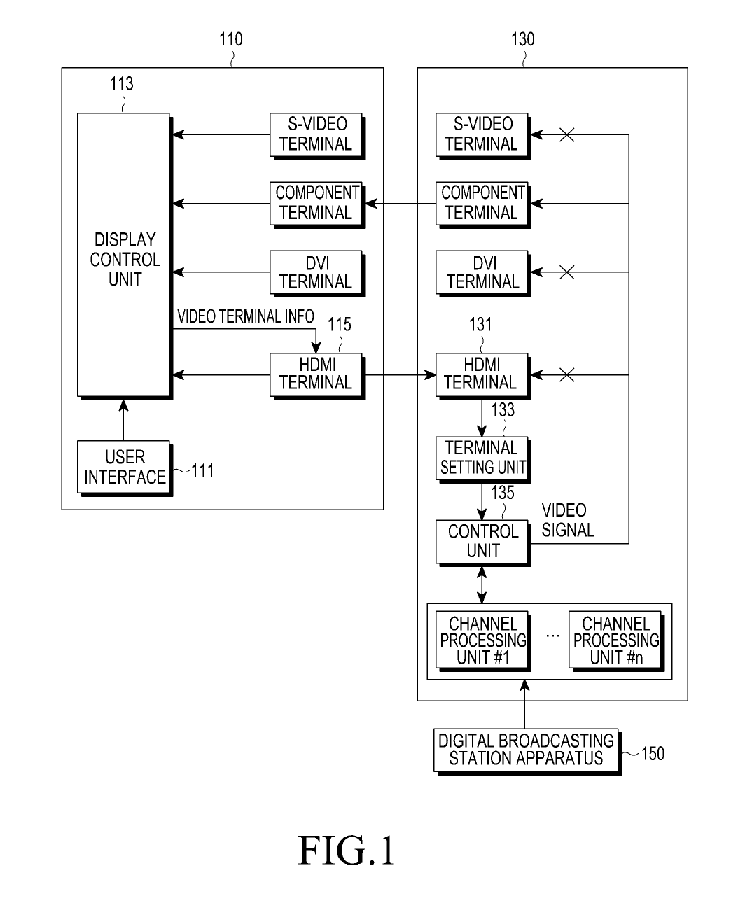

FIG. 1 is a block diagram illustrating the configuration of a power management system according to the related art.

Referring to FIG. 1, a power management system includes a display module 110, a digital broadcasting receiver 130, and a digital broadcasting station apparatus 150. When the power management system is described referring to FIG. 1, only elements which may be employed according to an exemplary embodiment of the present invention will be described, and a description of other elements will be omitted.

Specifically, the display module 110 includes a user interface 111, a display control unit 113, and a High Definition Multimedia Interface (HDMI) terminal 115. The digital broadcasting receiver 130 includes a HDMI terminal 131, a terminal setting unit 133, and a control unit 135.

First, when terminal information is input through the user interface 111, the input terminal information is transmitted to the digital broadcasting receiver 130 through the HDMI terminal 131 connected to the HDMI terminal 115. When the terminal setting unit 133 detects a terminal connected to the display module 110 by using the transmitted terminal information, the control unit 135 controls an output of the terminal according to a result of the detection. Namely, the control unit 135 generates only a signal of a terminal connected to display module 110, but does not generate signals of terminals other than the connected terminal.

However, disconnecting only Audio/Video (A/V) output terminals, including an S-video terminal, a component terminal, a Digital Video Interface (DVI) terminal and an HDMI terminal, as described above does not produce a large power reduction effect. Hence, a method is proposed for detecting a connection state of an output end and disabling unused A/V output terminals in the digital broadcasting receiver as follows.

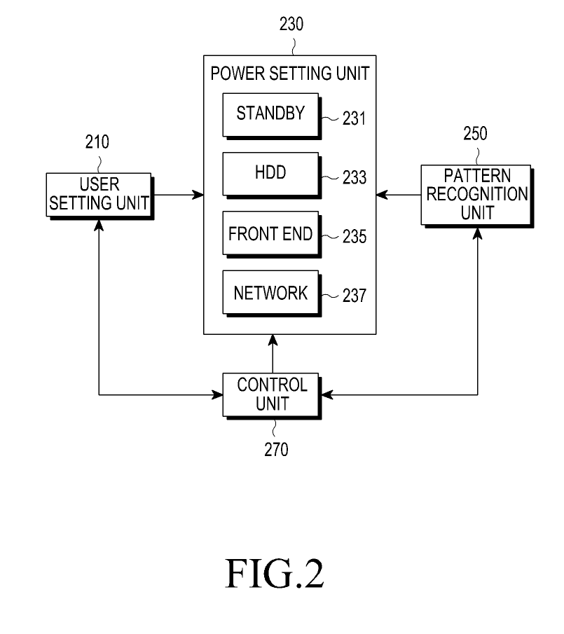

FIG. 2 is a block diagram illustrating a configuration of a digital broadcasting receiver according to an exemplary embodiment of the present invention.

Referring to FIG. 2, a digital broadcasting receiver includes a user setting unit 210, a power setting unit 230, a pattern recognition unit 250, and a control unit 270.

The user setting unit 210 manages information that a user inputs through a terminal in order to personally set his/her own pattern. In this case, the pattern according to setting by the user may include a prime bedtime, a prime viewing time zone, and a prime time zone and frequency of recording, etc. of the user.

The pattern recognition unit 250 analyzes and manages a use pattern of the user who uses the digital broadcasting receiver. In this case, the pattern according to the use of the digital broadcasting receiver may include an initial power on time of day, a final power off time of day, a viewing time for each time zone, a time zone and frequency of recording, a time zone and frequency of recording data reproduction, a time zone and frequency for a Picture-In-Picture (PIP) function, and a time zone and frequency of network use.

The power setting unit 230 receives data provided by the user setting unit 210 and the pattern recognition unit 250, and sets a plurality of power management items. In this regard, FIG. 2 shows that the plurality of the power management items includes only a standby 231, a Hard Disc Drive (HDD) 233, a front end 235, and a network 237. However, the power management items are not limited to these, and different or additional power management items may be employed according to an exemplary embodiment of the present invention.

The control unit 270 determines whether input data is data input through a terminal or data generated by the use of the digital broadcasting receiver. Then, the control unit 270 provides the input data to the user setting unit 210 and the pattern recognition unit 250 and controls in such a manner as to process the input data through the user setting unit 210 and the pattern recognition unit 250, based on the result of the determination. The control unit 270 may also control in such a manner that the power setting unit 230 can maintain or change power, based on the result of the processing by the user setting unit 210 and the pattern recognition unit 250.

The user setting unit 210 can set settings for a prime bedtime, a prime viewing time zone, and a prime time zone and frequency of recording, etc. of the user, which have been set to default, by using the input data through the terminal. At this time, the prime bedtime is used for the setting of a passive standby. The prime viewing time zone is used for the setting of an active standby. Also, the prime time zone and frequency of recording is used for power setting of the HDD and the front end.

Meanwhile, when the use of the digital broadcasting receiver begins, the pattern recognition unit 250 collects and stores information on a use pattern with respect to the digital broadcasting receiver. Then, the pattern recognition unit 250 analyzes the use pattern by using the stored data. Based on the result of the analysis, the user setting unit 210 can set an initial power on time of day, a final power off time of day, a viewing time for each time zone, a time zone and frequency of recording, a time zone and frequency of recording data reproduction, a time zone and frequency for a PIP function, a time zone and frequency of network use, etc. However, data, which can affect the analysis of the use pattern of the user (i.e. data on the use of the digital broadcasting receiver), may be further included besides the settable data as described above.

Herein, the initial power on time of day, the final power off time of day can affect the setting of a passive standby. The viewing time for each time zone can affect the setting of an active standby. Also, the time zone and frequency of recording, the time zone and frequency of recording data reproduction, the time zone and frequency for the PIP function, and the time zone and frequency of network use can affect power setting of the HDD and front end, HDD power setting, front end power setting, and network power setting, respectively.

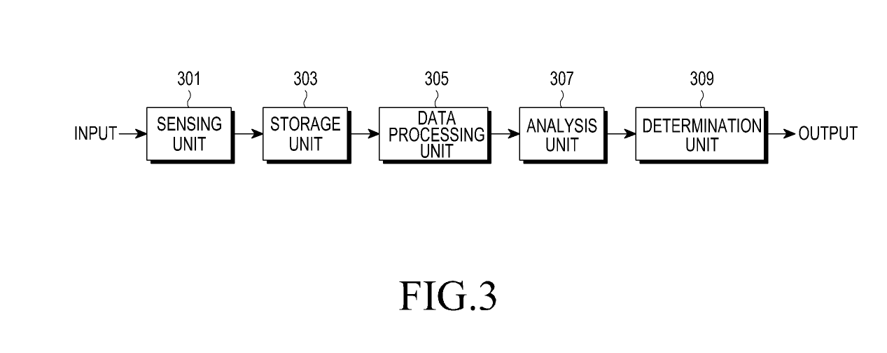

FIG. 3 is a block diagram illustrating a configuration of a pattern recognition unit according to an exemplary embodiment of the present invention.

Referring to FIG. 3, a pattern recognition unit 250 may include a sensing unit 301, a storage unit 303, a data processing unit 305, an analysis unit 307, and a determination unit 309.

First, the sensing unit 301 senses whether data is generated. At this time, the generated data is on the use of the digital broadcasting receiver. As assumed above, the generated data may be an initial power on time of day, a final power off time of day, a viewing time for each time zone, a time zone and frequency of recording, a time zone and frequency of recording data reproduction, a time zone and frequency for a PIP function, and a time zone and frequency of network use.

The storage unit 303 stores data sensed by the sensing unit 301. Also, afterwards, the storage unit 303 considers data, which is generated during a particular time period, as data to be stored in order to easily analyze a use pattern.

The data processing unit 305 determines whether it is necessary to process data stored in the storage unit 303. When it is determined that it is necessary to process the stored data, the data processing unit 305 processes the stored data, and makes it possible to analyze the processed data.

The analysis unit 307 analyzes a use pattern with respect to the digital broadcasting receiver by using data delivered through the data processing unit 305. As described above, the use pattern may also become an initial power on time of day, a final power off time of day, a viewing time for each time zone, a time zone and frequency of recording, a time zone and frequency of recording data reproduction, a time zone and frequency for a PIP function, and a time zone and frequency of network use.

The determination unit 309 determines whether it is necessary to set current power setting, based on the analysis result of the use pattern.

Meanwhile, power setting by the input of the user (i.e. using a terminal) is performed by the determination and a direct input of the user. Therefore, it is not necessary to store and analyze input data, and make a determination based on the analysis result as in power setting according to the pattern recognition as described above.

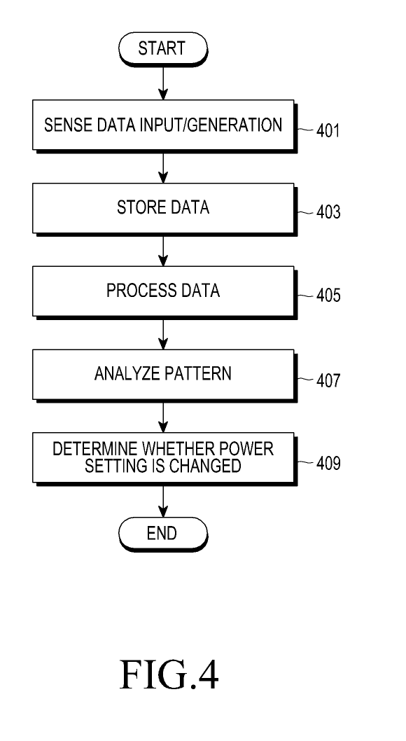

FIG. 4 is a flowchart showing a process for managing power of a digital broadcasting receiver by pattern recognition unit according to an exemplary embodiment of the present invention.

In step 401, the sensing unit 301 senses the generation of data. In step 403, the storage unit 303 stores the generated data. In step 405, the data processing unit 305 determines whether it is necessary to process the stored data. When it is necessary to process the stored data, the data processing unit 305 processes the stored data, and provides the processed data to the analysis unit 307. On the other hand, when it is not necessary to process the stored data, the data processing unit 305 does not process the stored data, and provides the stored data, which has not been processed, to the analysis unit 307. In step 407, the analysis unit 307 analyzes a use pattern by analyzing the data provided by the data processing unit 305. In step 409, the determination unit 309 determines whether power setting is set (i.e. whether power setting is changed), based on the analysis result of the use pattern.

Meanwhile, a process for managing power of the digital broadcasting receiver by the user setting unit 210 is not specially shown. However, the power management process by the user setting unit 210 is similar to the process as shown in FIG. 4 except for the step of analyzing the data, which is input during a process for managing power of the digital broadcasting receiver, by the pattern recognition unit 250.

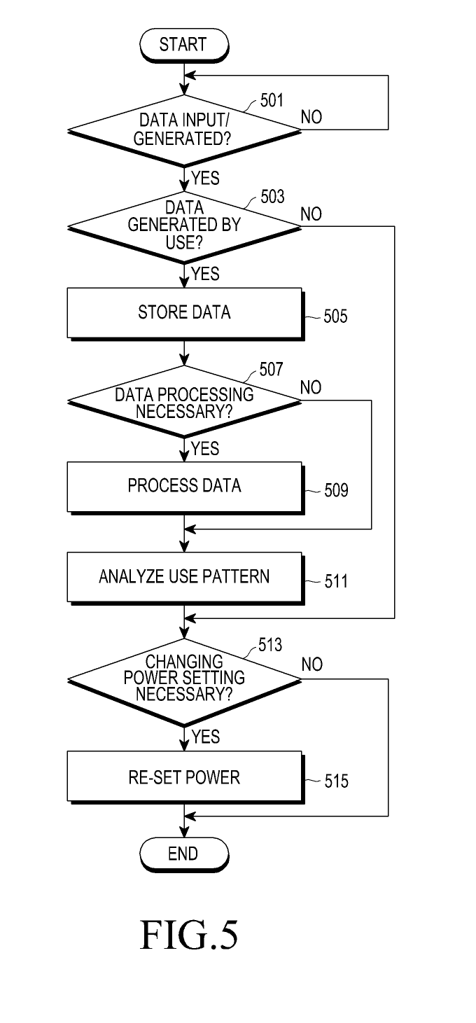

FIG. 5 is a flowchart showing a process for managing power by a digital broadcasting receiver according to an exemplary embodiment of the present invention.

First, the control unit 270 determines in step 501 whether data is input or is generated. In step 503, the control unit 270 determines whether the input data is data generated by the use of the digital broadcasting receiver. If it is determined in step 503 that the input data is the data generated by the use of the digital broadcasting receiver, the control unit 270 provides the generated data to the pattern recognition unit 250. In step 505, the pattern recognition unit 250 stores the provided data. At this time, the provided data is information on a use pattern with respect to the digital broadcasting receiver (i.e. information on whether the digital broadcasting receiver is used).

In step 507, the pattern recognition unit 250 determines whether it is necessary to process data, which has been stored during a particular time period, including data stored in step 505. If it is determined in step 507 that it is necessary to process the data, the pattern recognition unit 250 proceeds to step 509. In step 509, the pattern recognition unit 250 processes the data. Then, it proceeds to step 511. In step 511, the pattern recognition unit 250 analyzes a use pattern by using collected pattern information (i.e. the processed data). In contrast, if it is determined in step 507 that it is not necessary to process the data, the pattern recognition unit 250 proceeds to step 511. In step 511, the pattern recognition unit 250 analyzes a use pattern by using collected pattern information (i.e. the data stored during the particular time period).

After analyzing the use pattern as described above, the pattern recognition unit 250 determines in step 513 whether it is necessary to change the current power setting, based on the analysis result of the use pattern. If it is determined in step 513 that it is necessary to change the current power setting, the pattern recognition unit 250 proceeds to step 515. In step 515, the control unit 270 changes the power setting of the power setting unit 230. In contrast, if it is determined in step 513 that it is not necessary to change the current power setting, the operation is completed.

Meanwhile, when it is determined in step 503 that the input data is data input through a terminal, the control unit 270 proceeds to step 513.

According to the present invention as described above, unused A/V output terminals are disabled by detecting a connection state of an output end in a digital broadcasting receiver. Then, an optimized power reduction scheme is set by sensing a use pattern with respect to the digital broadcasting receiver. As a result, a waste of power can be reduced.

In the detailed description of the present invention as described above, data input by a user is limited to data input through a terminal. However, the data input by the user may include data directly input through a user interface, such as data input through a remote control, besides the data input through the terminal.

While the invention has been shown and described with reference to certain exemplary embodiments thereof, it will be understood by those skilled in the art that various changes in form and details may be made therein without departing from the spirit and scope of the invention as defined by the appended claims and equivalents.

What is claimed is:

1. An apparatus for managing power of a digital broadcasting receiver, the apparatus comprising:
a user setting unit for requesting power setting of the digital broadcasting receiver according to data input through a user interface;
a pattern recognition unit for recognizing a use pattern through data input according to use of the digital broadcasting receiver, and for requesting power setting of the digital broadcasting receiver according to the recognized use pattern; and
a power setting unit for setting the power of the digital broadcasting receiver by a request of at least one of the user setting unit and the pattern recognition unit.

2. The apparatus as claimed in claim 1, further comprising:
a control unit for determining whether input data is the data input through the user interface or the data input according to the use of the digital broadcasting receiver.

3. The apparatus as claimed in claim 1, wherein the data input through the user interface represents at least one of a prime bedtime, a prime viewing time zone, and a prime time zone and frequency of recording.

4. The apparatus as claimed in claim 1, wherein the data input according to the use of the digital broadcasting receiver represents at least one of an initial power on time of day, a final power off time of day, a viewing time for each time zone, a time zone and frequency of recording, a time zone and frequency of recording data reproduction, a time zone and frequency for a Picture-In-Picture (PIP) function, and a time zone and frequency of network use.

5. The apparatus as claimed in claim 1, wherein the pattern recognition unit further comprises:
a sensing unit for sensing the data input according to the use of the digital broadcasting receiver;
a storage unit for storing the sensed data;
an analysis unit for analyzing a use pattern by using data stored during a particular time period including the stored data; and
a determination unit for determining whether the power setting is set based on a result of the analysis.

6. The apparatus as claimed in claim 1, wherein the power setting unit comprises at least one of a standby, a Hard Disc Drive (HDD), a front end, and a network.

7. A method for managing power of a digital broadcasting receiver, the method comprising:
determining whether input data is data input through a user interface or data input according to use of the digital broadcasting receiver; and
setting the power based on a result of the determination.

8. The method as claimed in claim 7, further comprising:
requesting power setting of the digital broadcasting receiver according to the data input through the user interface when it is determined that the input data is the data input through the user interface.

9. The method as claimed in claim 7, further comprising:
analyzing a use pattern based on the data input according to the use of the digital broadcasting receiver when it is determined that the input data is the data input according to the use of the digital broadcasting receiver.

10. The method as claimed in claim 7, wherein the data input through the user interface represents at least one of a prime bedtime, a prime viewing time zone, and a prime time zone and frequency of recording.

11. The method as claimed in claim 7, wherein the data input according to the use of the digital broadcasting receiver represents at least one of an initial power on time of day, a final power off time of day, a viewing time for each time zone, a time zone and frequency of recording, a time zone and frequency of recording data reproduction, a time zone and frequency for a Picture-In-Picture (PIP) function, and a time zone and frequency of network use.

12. A method of managing power of a digital broadcasting receiver, the method comprising:
obtaining data related to a use of the digital broadcasting receiver;
storing the obtained data;
analyzing a pattern of use of the digital broadcasting receiver based on the stored data; and
determining whether a power setting of the digital broadcasting receiver is set based on the result of the analysis.

13. The method as claimed in claim 12, wherein the data on the use of the digital broadcasting receiver is input through a user interface of the digital broadcasting receiver.

14. The method as claimed in claim 12, wherein the data on the use of the digital broadcasting receiver is data generated by use of the digital broadcasting receiver.
